(19) United States
(12) Patent Application Publication
(10) Pub. No.: US 2022/0076154 A1
(43) Pub. Date: Mar. 10, 2022

(54) CONTROL PULSE GENERATION METHOD, SYSTEM, DEVICE AND STORAGE MEDIUM

(71) Applicant: BEIJING BAIDU NETCOM SCIENCE TECHNOLOGY CO., LTD., Beijing (CN)

(72) Inventors: Xin WANG, Beijing (CN); Lijing JIN, Beijing (CN); Shusen LIU, Beijing (CN); Zelin MENG, Beijing (CN); Zixian YAN, Beijing (CN)

(21) Appl. No.: 17/454,960

(22) Filed: Nov. 15, 2021

(30) Foreign Application Priority Data
Jan. 22, 2021 (CN) 202110091055.8

(51) Int. Cl. G06N 10/00

(52) U.S. Cl. CPC G06N 10/00

(57) ABSTRACT

A control pulse generation method, a system, a device and a storage medium are provided, which are related to the field of quantum computing. The method includes: acquiring a system Hamiltonian; acquiring an initial control pulse of a quantum logic gate included in a parameterized quantum circuit to obtain an initial pulse sequence for a gate sequence formed for all the quantum logic gates in the parameterized quantum circuit, which is obtained through simulation based on the system Hamiltonian; acquiring system state information of the quantum system obtained after applying the initial pulse sequence to the target quantum hardware device; adjusting a parameter of the parameterized quantum circuit based on a relationship between the system state information and target state information needed to be achieved by the target quantum control task, to adjust a pulse parameter of the initial pulse sequence to obtain a target pulse sequence.

### CROSS-REFERENCE TO RELATED APPLICATIONS

This disclosure claims priority to Chinese patent application, No. 202110091055.8, entitled “Control Pulse Generation Method, Apparatus, System, Device and Storage Medium”, filed with the Chinese Patent Office on Jan. 22, 2021, which is hereby incorporated by reference in its entirety.

### TECHNICAL FIELD

The present disclosure relates to the technical field of data processing, in particular to the field of quantum computing.

### BACKGROUND

Quantum computing is considered as the heart of the next generation of computing technology, and it is also a representative technology leading a new round of quantum revolution. In recent years, remarkable progress has been made in both the software and hardware fields of quantum computing. In the aspect of quantum software, a variety of applicable quantum algorithms and various quantum cloud platforms have been developed and applied successively recently. In the aspect of quantum hardware, there are many different types of quantum hardware candidates in the art, including superconducting circuits, ion traps, photon, NV color centers, nuclear magnetic resonance and so on. Different techniques show their own advantages, but of course they have corresponding challenges. It should be particularly noted that quantum software and quantum hardware are not naturally connected, and solving the gap between them requires certain technical support. Therefore, the connection between quantum software and quantum hardware plays an irreplaceable role in the whole quantum computing.

### SUMMARY

The present disclosure provides a control pulse generation method, an apparatus, a system, a device and a storage medium.

According to one aspect of the present disclosure, there is provided a control pulse generation method, including:

acquiring a system Hamiltonian, wherein the system Hamiltonian is constructed based on a relevant physical parameter of a target quantum hardware device and is used for characterizing a Hamiltonian of a quantum system corresponding to the target quantum hardware device; the target quantum hardware device is configured to achieve a target quantum control task, and the target quantum control task is characterized by a parameterized quantum circuit;

acquiring an initial control pulse of a quantum logic gate included in the parameterized quantum circuit, to obtain an initial pulse sequence for a gate sequence formed for all the quantum logic gates in the parameterized quantum circuit, wherein the initial control pulse is obtained through simulation based on the system Hamiltonian;

acquiring system state information of the quantum system obtained after applying the initial pulse sequence to the target quantum hardware device;

adjusting a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

According to another aspect of the present disclosure, there is provided a control pulse generation apparatus, including:

a Hamiltonian acquisition unit configured to acquire a system Hamiltonian, wherein the system Hamiltonian is constructed based on a relevant physical parameter of a target quantum hardware device and is used for characterizing a Hamiltonian of a quantum system corresponding to the target quantum hardware device; the target quantum hardware device is configured to achieve a target quantum control task, and the target quantum control task is characterized by a parameterized quantum circuit;

a control pulse acquisition unit configured to acquire an initial control pulse of a quantum logic gate included in the parameterized quantum circuit, to obtain an initial pulse sequence for a gate sequence formed for all the quantum logic gates in the parameterized quantum circuit, wherein the initial control pulse is obtained through simulation based on the system Hamiltonian;

a state information acquisition unit configured to acquire system state information of the quantum system obtained after applying the initial pulse sequence to the target quantum hardware device;

a target pulse sequence determination unit configured to adjust a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

According to another aspect of the present disclosure, there is provided a control pulse generation system, at least including: a terminal and a cloud server; wherein

the terminal is configured to receive a relevant physical parameter of a target quantum hardware device input by a user, and construct a system Hamiltonian characterizing the target quantum hardware device; the target quantum hardware device is configured to achieve a target quantum control task, and the target quantum control task is characterized by a parameterized quantum circuit;

the cloud server is configured to: acquire the system Hamiltonian; acquire an initial control pulse of a quantum logic gate included in the parameterized quantum circuit, to obtain an initial pulse sequence for a gate sequence formed for all the quantum logic gates in the parameterized quantum circuit, wherein the initial control pulse is obtained through simulation based on the system Hamiltonian; acquire system state information of the quantum system obtained after applying the initial pulse sequence to the target quantum hardware device; and adjust a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

According to another aspect of the present disclosure, there is provided an electronic device, including:

at least one processor; and

a memory communicatively connected to the at least one processor, wherein

the memory stores instructions executable by the at least one processor, and the instructions are executed by the at least one processor to cause the at least one processor to perform the method in any embodiment of the present disclosure.

According to another aspect of the present disclosure, there is provided a non-transitory computer readable storage medium storing computer instructions, wherein the computer instructions are executed by a computer to cause the computer to perform the method in any embodiment of the present disclosure.

According to another aspect of the present disclosure, there is provided a computer program product including a computer program which, when executed by a processor, causes the processor to perform the method in any embodiment of the present disclosure.

It should be understood that the content described in this section is not intended to identify key or important features of the embodiments of the present disclosure, nor to limit the scope of the present disclosure. Other features of the present disclosure will become easy to understand through the following description.

### BRIEF DESCRIPTION OF DRAWINGS

The attached drawings are for better understanding of the solution and do not constitute a limitation of the disclosure, in which:

FIG. 1 is a schematic flowchart of the implementation of a control pulse generation method according to an embodiment of the present disclosure;

FIG. 2 is a schematic flowchart of the implementation of a control pulse generation method in a specific example according to an embodiment of the present disclosure;

FIG. 3 is a schematic structural diagram of a parameterized quantum circuit in a specific example of a control pulse generation method according to an embodiment of the present disclosure;

FIG. 4 is a schematic structural diagram of a connectivity between qubits in a target quantum hardware device in a specific example of a control pulse generation method according to an embodiment of the present disclosure;

FIG. 5 is a schematic structural diagram of a parameterized quantum circuit charactering a mapping relationship in a specific example of a control pulse generation method according to an embodiment of the present disclosure;

FIGS. 6 and 7 are schematic diagrams of a target pulse sequence and a chromatographic pulse sequence in a specific example of a control pulse generation method according to an embodiment of the present disclosure;

FIG. 8 is another schematic flowchart of the implementation of a control pulse generation method according to an embodiment of the present disclosure;

FIG. 9 is yet another schematic flowchart of the implementation of a control pulse generation method according to an embodiment of the present disclosure;

FIG. 10 is a schematic structural diagram of a control pulse generation apparatus according to an embodiment of the present disclosure;

FIG. 11 is a schematic structural diagram of a control pulse generation system according to an embodiment of the present disclosure;

FIG. 12 is a block diagram of an electronic device for achieving the control pulse generation method according to an embodiment of the present disclosure.

### DETAILED DESCRIPTION OF EMBODIMENTS

Exemplary embodiments of the present disclosure are described below with reference to the accompanying drawings, which include various details of the embodiments of the present disclosure to facilitate understanding and should be considered as exemplary only. Therefore, those of ordinary skills in the art should appreciate that various changes and modifications can be made to the embodiments described herein without departing from the scope and spirit of the present disclosure. Also, for the sake of clarity and conciseness, descriptions of well-known functions and structures are omitted in the following description.

In order to achieve a specific quantum task, a quantum circuit composed of quantum logic gates (such as basic quantum gates) is usually constructed, thereby the quantum logic gates in the constructed quantum circuit are converted into pulse instructions that can be executed by quantum hardware, thus achieving the quantum circuit, that is, achieving the specific quantum task.

Moreover, in actual applications, in order to better deal with the gap between quantum hardware and quantum software, there are many different solutions in the art. One of the solutions is to adjust and control a physical signal (such as a control pulse) manually or semi-automatically according to experiences in the laboratory to adapt to a logical operation required to be performed by a quantum hardware device. This solution has great limitations, and the adjustment and the adaption need to be performed again if the quantum hardware device is replaced by another, which is inefficient. Here, it should be noted that the quantum hardware/software interface strongly depends on the type and architecture of a quantum hardware structure. Such as, for superconducting quantum computation, ion trap quantum computation, photon computation, and nuclear magnetic resonance quantum computation etc., the pulses applied in the process of quantum control are different. Therefore, how to design an automatic and efficient quantum control solution suitable for quantum hardware of different types/architectures has become an urgent problem to be solved. In other words, for quantum computers based on different physical principles and different physical architectures, such as superconducting quantum circuits, ion traps, nuclear magnetic resonance, etc., how to achieve various quantum tasks on any quantum hardware with a general purpose solution, such as quantum algorithms, pulse optimization, noise analysis, etc., has become an urgent problem to be solved.

Based on this, the disclosure provides a quantum control solution, that is, a control pulse generation method, an apparatus, a system, a device and a storage medium are provided. A user can upload Hamiltonian (also called system Hamiltonian) of a quantum hardware structure (or a quantum hardware device) and a quantum task to be performed (i.e., a target quantum control task) to a cloud, and the cloud constructs the workflow by calling various function modules required by the quantum control process according to the Hamiltonian of the quantum hardware structure and the specified task, thus, the quantum control task can be automatically performed in terms of pulse, and the target quantum control task can be achieved in terms of pulse. The quantum control task (such as, a target quantum control task) includes but not limited to pulse optimization, customizing a control pulse, simulating a quantum control system, submitting a quantum algorithm and generating a pulse, interfacing with third-party hardware (i.e., a quantum hardware device) and testing, etc.

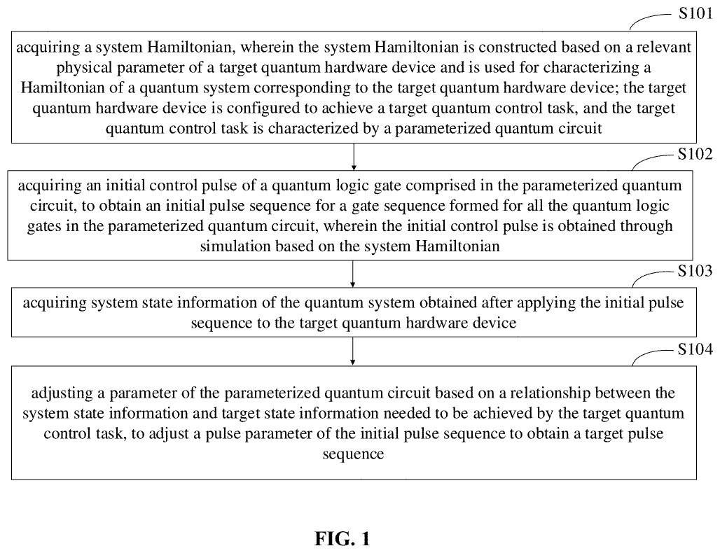

In particular, FIG. 1 is a schematic flowchart of the implementation of a control pulse generation method according to an embodiment of the present disclosure, as shown in FIG. 1, which is applied to a cloud server; the method including:

Step 101: acquiring a system Hamiltonian, wherein the system Hamiltonian is constructed based on a relevant physical parameter of a target quantum hardware device and is used for characterizing a Hamiltonian of a quantum system corresponding to the target quantum hardware device; the target quantum hardware device is configured to achieve a target quantum control task, and the target quantum control task is characterized by a parameterized quantum circuit. In an example, the system Hamiltonian is obtained from the client side corresponding to the cloud server.

Step 102: acquiring an initial control pulse of a quantum logic gate included in the parameterized quantum circuit to obtain an initial pulse sequence for a gate sequence formed for all the quantum logic gates in the parameterized quantum circuit, wherein the initial control pulse is obtained through simulation based on the system Hamiltonian.

Step 103: acquiring system state information of the quantum system obtained after applying the initial pulse sequence to the target quantum hardware device.

Step 104: adjusting a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device. That is to say, by adjusting the parameter of the parameterized quantum circuit, the pulse parameter of the simulated initial pulse sequence is indirectly adjusted, so that the target pulse sequence which can be applied to a real quantum hardware device can be obtained, and the target quantum control task can be achieved in the real quantum hardware device, that is the target quantum hardware device, utilizing the target pulse sequence.

In this way, the present disclosure provides a set of general-purpose solutions, which can achieve any target quantum control task on any quantum hardware (i.e., a target quantum hardware device), also, quantum computing software ((i.e., quantum software) can be combined with quantum computing hardware (i.e., quantum hardware), that is, the quantum computing software is used to obtain a target pulse sequence applied to a given quantum hardware device (i.e., a target quantum hardware device), so that a given quantum task (i.e., a target quantum control task) is realized based on the obtained target pulse sequence.

In a specific example of the solution of the present disclosure, the initial control pulse can be obtained in the following manner, specifically including:

acquiring an initial simulated pulse of the quantum logic gate included in the parameterized quantum circuit. Here, the initial simulated pulse may be a preset optimal pulse matched with the quantum logic gate, or a simulated pulse randomly generated; which is not limited in the solution of the present disclosure. For example, a parameterized quantum circuit may include a plurality of quantum logic gates, wherein initial simulated pulses corresponding to some of the quantum logic gates may be preset fixed values (i.e., preset optimal pulses), while pulses of other logic gates are non-fixed values, such as randomly generated values. For example, for a single-qubit-logic-gate, the initial simulated pulse is randomly generated, and for a two-qubit-logic-gate, the initial simulated pulse is a preset fixed value.

Further, dynamical evolution processing is performed on the system Hamiltonian based on the initial simulated pulse of the quantum logic gate included in the parameterized quantum circuit, to simulate the application of the initial simulated pulse to physical qubits in the target quantum hardware device, and a simulated quantum gate achieved by the initial simulated pulse is obtained through simulation; a pulse parameter of the initial simulated pulse is optimized based on a relationship between the simulated quantum gate obtained through simulation and the quantum logic gate, to obtain the initial control pulse of the quantum logic gate included in the parameterized quantum circuit, wherein an approximate quantum logic gate can be obtained based on the initial control pulse, and a fidelity of the approximate quantum logic gate from the quantum logic gate meets a preset fidelity rule. That is to say, the evolution process is simulated based on the system Hamiltonian of the target quantum hardware device to obtain a quantifiable result, such as the simulated quantum gate that can be achieved is obtained through evolution, and the initial simulated pulse is optimized based on the quantifiable result, which lays a foundation for simplifying the overall optimization process and improving the overall processing efficiency.

In a specific example of the solution of the present disclosure, the optimization can also be carried out in the following way, specifically, the method further includes:

evolving to obtain a first target function at least based on the system Hamiltonian and the logical quantum gate included in the parameterized quantum circuit, wherein the first target function can characterize the relationship between the simulated quantum gate obtained by simulating the application of the initial pulse sequence to the target quantum hardware device and the logical quantum gate included in the parameterized quantum circuit. For example, a simulator can use a built-in algorithm to solve the Schrodinger equation numerically to simulate the unitary matrix of the simulated quantum gate Uᵣₑₐₗ:

$$i ℏ \frac{d {U}_{real}}{d t} = {H}_{s y s} {U}_{real} , \qquad ( 4 )$$

and to define the first target function of the pulse containing the quantum logic gate as:

$$F = \frac{\vert tr ( {U}_{goal}^{†} {U}_{real} ) \vert}{dim ( {U}_{goal} )} , \qquad ( 5 )$$

wherein, U_{goal} is the unitary matrix of the quantum logic gate included in the parameterized quantum circuit, and formula (5) depicts the fidelity of the pulse, in which dim(U_{goal}) characterizes the dimension of the quantum logic gate. Then, various optimization algorithms built in an optimizer, such as gradient ascent method, piecewise random method, gradient optimization analysis control method, are used to optimize the parameter of the pulse to minimize the first target function, and the control pulse with high fidelity is obtained.

Based on this, optimizing the pulse parameter of the initial simulated pulse based on the relationship between the simulated quantum gate obtained through simulation and the quantum logic gate to obtain the initial control pulse of the quantum logic gate included in the parameterized quantum circuit, specifically includes:

optimizing the pulse parameter of the initial simulated pulse to minimize the first target function to obtain a minimum function value, wherein a simulated quantum gate corresponding to the minimum function value is the approximate quantum logic gate; taking a simulated pulse corresponding to the minimum function value as the initial control pulse of the quantum logic gate included in the parameterized quantum circuit. That is to say, the result is quantified by means of setting a target function, and the optimization process is completed with the quantifiable result, which lays a foundation for improving the optimization efficiency.

In a specific example of the solution of the present disclosure, in actual applications, in a case that the target quantum control task includes a plurality of quantum logic gates, even if the obtained approximate quantum logic gates meet the preset fidelity requirement, after all the approximate quantum logic gates are combined, the obtained quantum gate will deviate from the expected approximate quantum logic gate due to crosstalk and other problems, resulting in the fidelity of the obtained quantum gate no longer meeting the preset fidelity requirement. Based on this, the obtained initial control pulse can be further optimized. In particular, the method also includes:

mapping logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits.

Based on this, obtaining the initial pulse sequence for the gate sequence formed for all the quantum logic gates in the parameterized quantum circuit includes:

in a case that there are two or more quantum logic gates included in the parameterized quantum circuit, performing timing and/or order based optimization processing on the initial control pulses of the respective quantum logic gates included in the parameterized quantum circuit based on the mapping relationship characterized by the target parameterized quantum circuit, and simulating to obtain the initial pulse sequence;

here the approximate quantum logic gate can be obtained based on the control pulse included in the initial pulse sequence, and a fidelity of the approximate quantum logic gate from the quantum logic gate meets a preset fidelity rule. Thus, a foundation is laid for improving the accuracy of the initial pulse sequence and simplifying the overall optimization process.

In a specific example of the solution of the present disclosure, the system state information of the quantum system can be obtained in the following way, specifically including: acquiring a chromatographic pulse sequence; acquiring a measurement result returned after applying the chromatographic pulse sequence, after the target pulse sequence is applied to the target quantum hardware device. That is, first the target pulse sequence is applied to the target quantum hardware device, and the chromatographic pulse is applied to the target quantum hardware device after the application of the target pulse sequence is completed, thus obtaining the measurement result.

Based on this, the above acquiring the system state information of the quantum system obtained after applying the initial pulse sequence to the target quantum hardware device specifically includes: obtaining state information of each physical qubit in the target quantum hardware device based on the measurement result, to obtain the system state information of the quantum system. That is to say, based on the measurement result returned by the target quantum hardware device, the state information of each physical qubit in the target quantum hardware device can be obtained through analysis, and the system state information of the quantum system can be obtained, thus laying a data foundation for the subsequent targeted parameter adjustment.

In a specific example of the solution of the present disclosure, the parameter of the parameterized quantum circuit can also be optimized as follows. Specifically, a second target function for the parameterized quantum circuit can be obtained, wherein the second target function may be specifically a loss function set for the optimization algorithm of the parameterized quantum circuit; and a function value corresponding to the system state information is calculated based on the second target function.

Based on this, the above adjusting the parameter of the parameterized quantum circuit based on the relationship between the system state information and the target state information needed to be achieved by the target quantum control task, to adjust the pulse parameter of the initial pulse sequence to obtain the target pulse sequence, specifically includes:

in a case that it is determined that the second target function does not meet a function rule based on the function value corresponding to the system state information, such as, in a case that the second target function does not converge, adjusting the parameter of the parameterized quantum circuit to adjust the pulse parameter of the initial pulse sequence, and newly obtaining system station information corresponding to an adjusted initial pulse sequence and newly obtaining a function value, until the second target function meets the function rule; and taking an initial pulse sequence from which the function rule is met as the target pulse sequence. In this way, by adjusting the parameter of the parameterized quantum circuit, the pulse parameter of the simulated initial pulse sequence is indirectly adjusted, so that the target pulse sequence which can be applied to a real quantum hardware device can be obtained, and the target quantum control task can be achieved in a real quantum hardware device (i.e. a target quantum hardware device) utilizing the target pulse sequence.

In a specific example of the solution of the present disclosure, a visualization display can also be performed, such as taking at least the system state information of the quantum system as an output result and displaying the output result in a visual interactive interface. In an example, the system state information of the quantum system includes the state information of each physical qubit in the target quantum hardware device. In actual applications, the output result may be set based on actual requirements, which is not limited in the solution of the disclosure. In this way, the user experience is improved through the solution of visual display.

It is to be noted that, the visual interactive interface can be displayed on the cloud server side, or on the client side, which is not limited in the solution of the present disclosure.

To sum up, the solution of the present disclosure provides an automatic and efficient quantum control solution adapted to quantum hardware of different types/architectures, also, quantum computing software (i.e., quantum software) can be combined with quantum computing hardware (i.e., quantum hardware), that is, the quantum computing software is used to obtain a target pulse sequence used for applying to a given quantum hardware device (i.e., a target quantum hardware device), so that, a given quantum task (i.e., a target quantum control task) is achieved based on the obtained target pulse sequence.

In the following, the solution of the present disclosure will be further described in detail combined with specific examples. Specifically, the solution of the present disclosure provides a new modular quantum control solution. A user interacts with the cloud server through Hamiltonian as the basic data format, utilizes abundant extensible and modular quantum control functional modules, and assembles and invokes the functional modules using a procedural approach. In this way, abundant quantum control tasks are achieved and the practicability, extensibility and universality of the solution of the present disclosure are improved.

At the same time, the solution of the present disclosure can also be deployed on the cloud server, and with the help of the powerful computing power of the cloud server, the classical computing speed of performing the quantum control task is greatly improved, thereby improving the overall processing efficiency.

Here, firstly, the quantum control solution provided by the solution of the present disclosure and core functional modules thereof are outlined. Secondly, a specific quantum task will be taken as an example to display the whole process of the solution of the present disclosure. Finally, possible application scenarios of the solution of the present disclosure are given.

Part one: overview of the quantum control solution.

The solution of the present disclosure provides a quantum control cloud service architecture for the quantum control solution, which mainly includes two parts of a client and a cloud server. A user creates and submits a quantum control task (that is, a target quantum control task) to be performed through the client. The client communicates with the cloud server through the Hamiltonian, which is the Hamiltonian of the quantum system characterized by the quantum hardware device for performing the target quantum control task, and may also be referred to as the system Hamiltonian. Here, the system Hamiltonian includes, but not limited to the following information: a physical model, a hardware parameter, a pulse waveform and a pulse parameter of the quantum hardware device performing the target quantum control task. A quantum control solution in terms of pulse of the target quantum control task is obtained through the cloud server, such as, a target pulse sequence is obtained, which can achieve the target quantum control task based on the target quantum hardware device selected by the user. Finally, the calculation result of the whole process can be directly returned to the user, or it can be connected to real quantum hardware (that is, the quantum hardware device used to perform the target quantum control task) to control and return the reading result. The more specific description is explained as follows.

Client: first, the user creates a target quantum control task locally. The user can create one target quantum control task by self-definition or using a template preset by this service. The target quantum control task is a control task to achieve the quantum computing hardware in terms of pulse, including but not limited to: single-qubit-gate, two-qubit-gate, quantum algorithm, quantum gate calibration, self-definition of pulse and so on. According to a relevant physical parameter (such as the physical model, etc.) of the target quantum hardware device determined by the user, for example, the target quantum hardware device may be customized by the user or selected from preset quantum hardware structures, the system Hamiltonian of the quantum system characterized by the target quantum hardware device is constructed, and the system Hamiltonian and the created target quantum control task are uploaded to the cloud server.

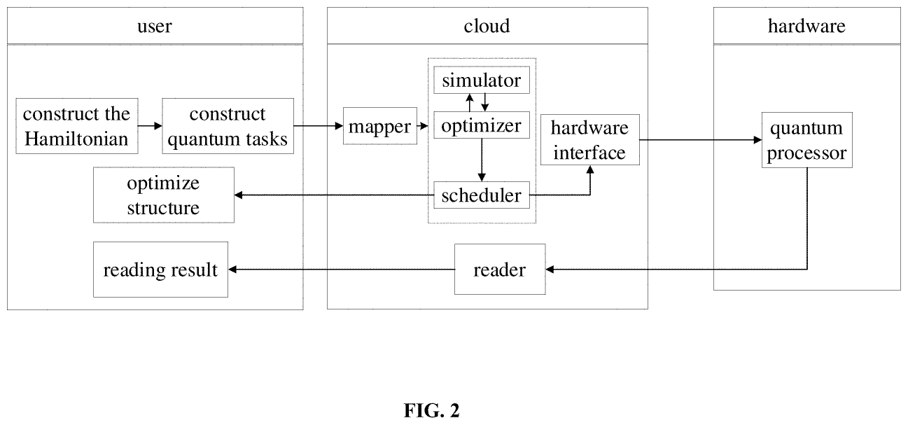

In actual applications, as shown in FIG. 2, the client can preset a plurality of functional modules for users to use, including but not limited to a quantum task definition module, a Hamiltonian definition module, a result returning and processing module.

The quantum task definition module is used to provide a template for a quantum control task, and support a user to customize a target quantum control task by using various built-in functions.

The Hamiltonian definition module is used to provide a relevant physical parameter of a quantum hardware device and create a Hamiltonian according to the physical model of the quantum system selected by the user (that is, the quantum system characterized by the target quantum hardware device). The Hamiltonian includes the following information of quantum system, including but not limited to: structure information of the quantum hardware device, a hardware parameter of the quantum hardware device, a pulse parameter, a pulse waveform, a pulse sequence, the number of physical qubits and energy level of each physical qubit, etc.

The result returning and processing module (i.e., a result processing module) is used to receive the result returned by the cloud server and perform data and visualization processing on the returned result, such as displaying the evolution animation of the quantum state of the returned physical qubit in Bloch sphere, pulse sequence diagram, reading distribution diagram of I-Q plane, reading noise distribution, etc.

Cloud server: after receiving the system Hamiltonian and the target quantum control task uploaded by the client, the cloud server will invoke various corresponding functional modules according to the target quantum control task and the system Hamiltonian to achieve the target quantum control task. The cloud server also provides an interface for third-party hardware (such as a real target quantum hardware device), and transmits a generated pulse instruction (such as a target pulse sequence) for achieving the target quantum control task onto the real target quantum hardware device, such as a quantum processor.

Further, the quantum processor returns the reading result read after applying the pulse instruction to the cloud server. The cloud server can also invoke a reader set by itself to process the reading result. The cloud server returns the processing result to the client in the form of Hamiltonian. From the returned processing result displayed in the form of Hamiltonian, the user can extract the following information, including but not limited to: a pulse sequence, a pulse parameter, a fidelity, a dynamic evolution of quantum state, a reading result of the quantum hardware device, etc.

In particular, as shown in FIG. 2, the cloud server (that is, the cloud) has a plurality of functional modules for selection, including but not limited to a mapper, a simulator, an optimizer, a scheduler, a hardware interface, a benchmark test module and a reader.

The mapper can map a logical qubit corresponding to the target quantum control task to a physical qubit of the target quantum hardware device according to an algorithm of double-qubit-gate of non-adjacent qubits. That is, a quantum logic gate in the target quantum control task is converted into a pulse instruction executable by the quantum hardware.

The simulator solves the evolution process of state information (such as a quantum state of a qubit) of a quantum system indicated by the target quantum hardware device, according to the Schrodinger equation and Hamiltonian numerical value. For example, after the optimizer determines an initial simulated pulse for a quantum logic gate in the target quantum control task, the simulator simulates the evolution process of applying the initial simulated pulse to the target quantum hardware device and simulates to obtain a simulated quantum gate achieved by the target quantum hardware device, thus, the initial simulated pulse is optimized to obtain the initial control pulse. That is to say, the evolution process is simulated by the simulator based on the system Hamiltonian of the target quantum hardware device to obtain a quantifiable result, such as the simulated quantum gate that can be achieved is obtained through evolution.

The optimizer is provided with a built-in optimization function to optimize the pulse parameter, and optimize the control pulse to make the pulse fidelity higher, and lays a foundation for achieving the quantum logic gate indicated by the target quantum control task with high fidelity. The optimizer can obtain control pulses (i.e., initial control pulses) to achieve all quantum logic gates indicated by the target quantum control task, and the fidelity of a simulated quantum gate obtained by the initial control pulse from a corresponding quantum logic gate meets the preset fidelity requirement (i.e., the preset fidelity rule). Here, to simplify the description, a simulated quantum gate meeting the preset fidelity requirement is called as an approximate quantum logic gate. That is to say, based on an initial control pulse optimized by the optimizer, an approximate quantum logic gate can be obtained.

The scheduler orders or further optimizes the control pulses of all quantum logic gates in the target quantum control task to obtain a pulse sequence with higher fidelity (such as, the initial pulse sequence obtained in the intermediate optimization process), to achieve the target quantum control task. The scheduler supports a full microwave pulse controlled cross-resonance quantum gate and a magnetic flux controlled controlled-phase quantum gate. In actual applications, the control pulse optimized or sequenced by the scheduler is the initial control pulse output by the optimizer, and the control pulse with high fidelity obtained by the optimizer is further optimized or sequenced from the dimension of the whole target quantum control task, to obtain the initial pulse sequence.

In actual applications, in a case that the target quantum control task includes a plurality of quantum logic gates, even if the respective approximate quantum logic gates obtained based on the optimizer meet the preset fidelity requirement, after all the approximate quantum logic gates are combined, the obtained quantum gate will deviate from the expected approximate quantum logic gate due to crosstalk and other problems, resulting in the fidelity of the obtained quantum gate no longer meeting the preset fidelity requirement. Based on this, a scheduler is also needed to further optimize the initial control pulse obtained by the optimizer. Here, the optimization of the scheduler may also include the optimization in timing or order, enabling the obtained initial pulse sequence to simulate the gate sequence formed by the plurality of quantum logic gates included in the target quantum control task.

The hardware interface (i.e., a hardware interface module) converts the pulse sequence output by the scheduler (such as the initial pulse sequence) into a pulse that can be accepted and executed by a quantum hardware device, according to the quantum hardware device based on different physical principles and structures provided by a third party.

The benchmark test module provides functions such as quantum state chromatography, quantum process chromatography and random quantum gate test, in terms of pulse.

The reader (that is, a reading module) obtains the reading result returned by the quantum hardware device provided by the third party and forwards it to the client.

In this way, the interaction between the client and the cloud server is achieved through the system Hamiltonian, and a given quantum control task is achieved in the cloud server. In this process, the user can use any physical model of a quantum hardware device, thus meeting the user's requirements of performing a quantum control task by quantum hardware devices based on different physical principles, in terms of quantum hardware.

Moreover, the solution of the present disclosure starts from the logic of quantum control, combines with the cloud service architecture of quantum control, and provides a set of functional modules for achieving the quantum control solution, which are connected with and invoked by each other through certain interfaces. For example, for a given quantum control task, different functional modules can be invoked and assembled procedurally, and an automated workflow is formed to achieve the given quantum control task, which has strong practicability and expansibility.

Part two: presentation of the whole process of performing a quantum control task by using the quantum control cloud service architecture described above.

In order to discuss the overall structure of the quantum control solution described in the solution of the present disclosure and the relationship among various functional modules more clearly, the Variational Quantum Eigensolver (VQE) algorithm below is taken as the optimization algorithm selected by the user and taken as an example to illustrate. Here, it should be noted that the optimization algorithm is merely an example for description, in actual applications, the solution of the present disclosure can also support more complex and abundant algorithms to achieve quantum control tasks. In the following, the VQE algorithm is combined to illustrate how this architecture achieves the connection between quantum software and quantum hardware. The specific steps includes:

Step 1: A System Hamiltonian is Defined and a Target Quantum Control Task is Created on the Client Side.

Based on the Hamiltonian definition module in the client, the user customizes or selects a relevant physical parameter of a target quantum hardware device for performing the target quantum control task based on the preset quantum hardware structure (in which the relevant physical parameter includes but not limited to the number, energy level, discord strength of qubits, coupling strength between multiple qubits, dissipation rate, resolution of an arbitrary wave generator, etc.), and defines the specific form of the Hamiltonian according to the physical model of the target quantum hardware device. In particular, firstly, a drift term H_{drift} related to the number of qubits, energy levels and coupling structure in the Hamiltonian is defined in matrix form of operators:

$${H}_{drift} = {\sum }_{i} {ω}_{i} {a}_{i}^{†} {a}_{i} + {\sum }_{i} \frac{{α}_{i}}{2} {a}_{i}^{†} {a}_{i}^{†} {a}_{i} {a}_{i} + {\sum }_{m , n} \frac{{g}_{m , n}}{2} ( {a}_{m}^{†} {a}_{n} + {a}_{m} {a}_{n}^{†} ) , \qquad ( 1 )$$

wherein parameters related to quantum hardware are the intrinsic frequency ωᵢ, discord αᵢ and coupling strength gₖₘ of a qubit, while αᵢ and αᵢ^{†} are the rising operator and lowering operator of the i-th qubit respectively. Then, a control item H_{ctrl} related to pulse channel and pulse waveform is defined in matrix form of operators:

H_{ctrl}=ΣₖΩₖ(\vec{α},t)Hₖ, (2)

wherein, Ωₖ(\vec{α}, t) is a control function depicting the pulse, and a is a parameter related to the pulse, Hₖ is used to characterize the coupling form between the control pulse and the quantum system.

Finally, the system Hamiltonian defined at the client is:

H_{sys}=H_{drift}+H_{ctrl}, (3).

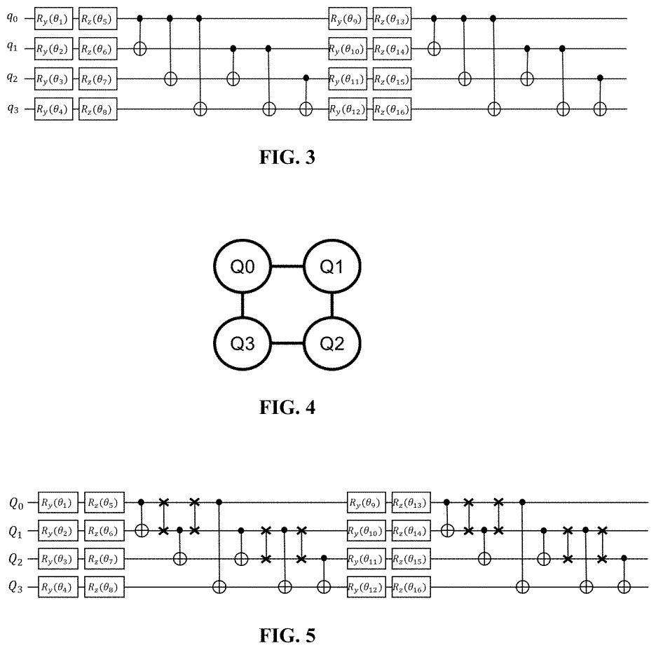

In the quantum task definition module in the client, a parameterized quantum circuit based on the VQE algorithm is obtained by using a built-in template or through self-definition, the parameterized quantum circuit is the logical quantum circuit to achieve the target quantum control task, and the VQE algorithm is the optimization algorithm of the whole optimization process. Further, the parameterized quantum circuit includes one or more quantum logic gates. Here, in a case that a plurality of quantum logic gates are included, the plurality of quantum logic gates may be recorded in the way of gate sequence, as shown in FIG. 3, a parameterized quantum circuit including four logical qubits {q₀, q₁, q₂, q₃} is selected for illustration in this example.

As shown in FIG. 3, the parameter \vec{θ}=(θ₁, θ₂, θ₃, . . θₙ₋₁, θₙ) of the parameterized quantum circuit is initialized, and the unitary matrix of the parameterized quantum circuit is set as U(\vec{θ}), in the following, U(\vec{θ}) is used to characterize the parameterized quantum circuit. The system Hamiltonian H_{sys} and the parameterized quantum circuit of the VQE algorithm are uploaded to the cloud server for processing. Here, in this example, data structures of the system Hamiltonian and the target quantum control task (corresponding to the quantum task in the following table) are shown in the following table:

| | Hardware Parameter | Operator Form |
|---|---|---|
| Drift | qubit frequency | disorder term |
| Hamiltonian | discord | discord term |
| | coupling strength | coupling term |
| | Pulse Parameter | Operator Form |
| Control | pulse waveform | microwave control |
| Hamiltonian | the number of pulses | magnetic flux |
| | pulse channel | control |
| | pulse time | |
| | Task Creation | Result Return |
| Quantum | parameterized | optimized pulse |
| Task | quantum circuit | sequence |
| | target function | time-evolution |
| | | operator |
| | | elapsed time of task |
| | | ground state energy |

Step 2: The Cloud Server Processes the Target Quantum Control Task.

After receiving the system Hamiltonian and the parameterized quantum circuit charactering the target quantum control task, the cloud server first invokes the mapper to map the logical qubits in the parameterized quantum circuit onto the physical qubits of the target quantum hardware device. For example, according to the preset mapping relationship between the logical qubits and the physical qubits in the quantum hardware device, the logical qubits in the parameterized quantum circuit are mapped onto the physical qubits of the target quantum hardware device. Such as, in a case that a non-adjacent CNOT gate in a parameterized quantum circuit is achieved in a real superconducting quantum circuit (i.e., the target quantum hardware device), it is necessary to map logical qubits onto a plurality of adjacent physical qubits in the real superconducting quantum circuit according to the coupling structure of quantum hardware. For example, as shown in FIG. 4, the connectivity of physical qubits of the target quantum hardware device is as follows:
{{Q₀,Q₁}, {Q₁,Q₂},{Q₂,Q₃},{Q₃,Q₀}}.

At this time, based on the connectivity of physical qubits as shown in FIG. 4, after mapping the logical circuit bits in the parameterized quantum circuit as shown in FIG. 3 onto the physical qubits, a quantum circuit structure as shown in FIG. 5 is obtained, that is, a target parameterized quantum circuit that characterizes the mapping relationship between logical qubits and physical qubits.

Further, after the mapping process of mapping the logical qubits to the physical qubits is completed, each quantum logic gate in the parameterized quantum circuit is compiled to obtain an initial pulse parameter, which may also be called as an initial simulated pulse. The initial simulated pulse corresponding to the quantum logic gate is put into the control item of the system Hamiltonian, the simulator of the cloud server is invoked to evolve to obtain the state information of the quantum system after applying the initial simulated pulse (i.e., simulating the application of the initial simulated pulse to the qubits in the target quantum hardware device), in other words, a simulated quantum gate that can be achieved by the initial simulated pulse is obtained through simulation. Then, the optimizer is invoked to optimize the initial simulated pulse based on the target state information required to be achieved by the target quantum control task, or the optimizer is invoked to optimize the initial simulated pulse based on a quantum logic gate required to be achieved by the target quantum control task. At the same time, the simulator is used to further evolve to obtain the state information of the quantum system or the quantum logic gate that can be achieved after applying the optimized initial simulated pulse, thus, the optimizer further optimizes the pulse based on the evolution result (i.e., the state information of the quantum system based on the current pulse) until a control pulse with high-fidelity is obtained. Here, the fidelity of the simulated quantum gate obtained based on the high-fidelity control pulse from the corresponding quantum logic gate meets the preset fidelity requirement, and the high-fidelity control pulse may be used as the initial control pulse.

Here, the simulator may use a built-in algorithm to solve the Schrodinger equation numerically, to simulate the unitary matrix Uᵣₑₐₗ of the resulted simulated quantum gate:

$$i ℏ \frac{d {U}_{real}}{d t} = {H}_{s y s} {U}_{real} , \qquad ( 4 )$$

and the first target function of the pulse including the quantum logic gate is defined as:

$$F = \frac{\vert tr ( {U}_{goal}^{†} {U}_{real} ) \vert}{dim ( {U}_{goal} )} , \qquad ( 5 )$$

wherein, U_{goal} is the unitary matrix of the quantum logic gate included in the parameterized quantum circuit, and the formula (5) depicts the fidelity of the pulse, in which dim(U_{goal}) characterizes the dimension of the quantum logic gate. Various optimization algorithms built in the optimizer, such as a gradient ascent method, a piecewise random method, a gradient optimization analysis control method, are used to optimize the parameter of the pulse to minimize the first target function, and the control pulse with high fidelity is obtained.

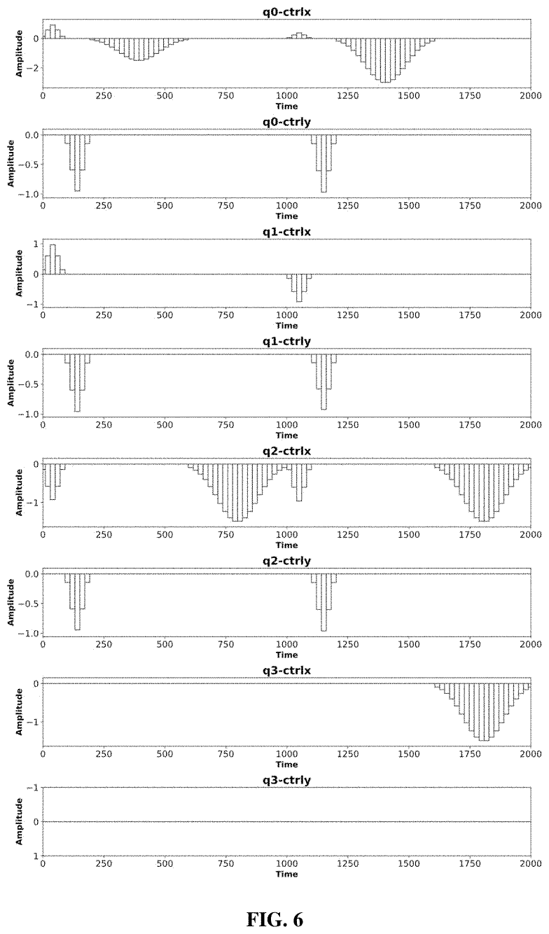

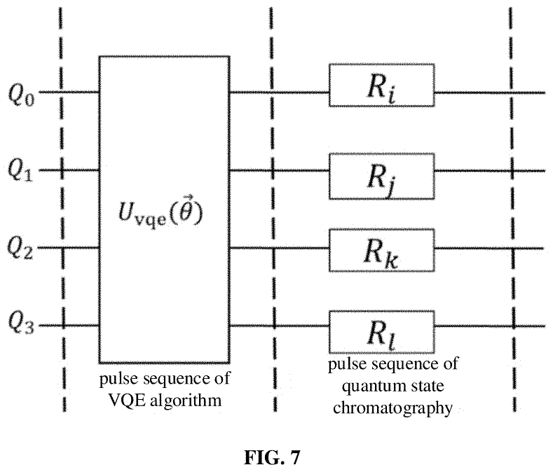

The scheduler obtains optimal control pulses optimized by the optimizer to achieve respective quantum logic gates in the parameterized quantum circuit, that is, an initial control pulse of which the fidelity meets the preset fidelity requirement. According to the built-in scheduling rule matched with the target quantum hardware device and the quantum circuit structure obtained after the mapper completes the mapping of qubits, all the acquired control pulses are arranged and scheduled to obtain an initial pulse sequence for the parameterized quantum circuit. Then the benchmark test module is invoked to generate a chromatographic pulse sequence for quantum state chromatography, and finally a VQE quantum circuit pulse sequence (i.e., the initial pulse sequence) for achieving the parameterized quantum circuit and the chromatographic pulse sequence for quantum state chromatography are obtained as shown in FIGS. 6 and 7.

Further, after obtaining the initial pulse sequence and the chromatographic pulse sequence, the hardware interface is invoked, and the initial pulse sequence and the chromatographic pulse sequence are processed, according to API (application programming interface) of different third-party hardware, and then sent to a real target quantum hardware device, such as a quantum processor. Then, after obtaining the reading result on the quantum processor side, the reading result is sent to the cloud server, and the cloud server invokes its own reader to process the reading result to obtain the unitary matrix U_{vqe}(\vec{θ}) of the parameterized quantum circuit, and obtain the quantum state p of the physical qubit after the initial pulse sequence acts on the target quantum hardware device, and the expected value [symbol] H_{vqe} [symbol] is calculated:

[symbol]

H_{vqe} [symbol] =tr(H_{vqe}ρ);

here, (tr(H_{vqe}ρ) characterizes the second target function corresponding to the VQE algorithm; and according to the expected value output, the parameter B of the parameterized quantum circuit is further adjusted by the optimizer to optimize the pulse parameter and further obtain the unitary matrix U(\vec{θ}) of the updated parameterized quantum circuit.

The above iteration is repeated until the reader obtains the locally minimized expected value [symbol] H_{vqe} [symbol] and the ground state energy E_{g}= [symbol] H_{vqe} [symbol] corresponding to the minimum expected value. At this time, a pulse sequence corresponding to the minimum expected value is the target pulse sequence for achieving the target quantum control task, which is the control solution for achieving the target quantum control task, in terms of pulse.

In a case that the ground state energy E_{g} is found, the reader returns the target pulse sequence corresponding to the optimized parameterized quantum circuit and the fidelity thereof, optimized unitary matrix U(\vec{θ}), ground state energy, running time, density matrix and other results to the client, and invokes the result returning and processing module at the client to visualize the returned result.

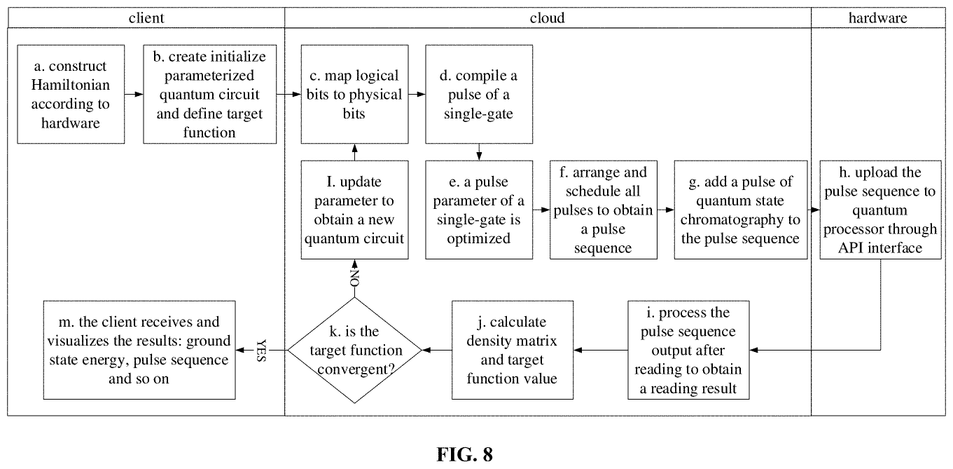

As shown in FIG. 8, the specific steps to achieve the quantum control solution of the present disclosure include following steps.

Step a: a user obtains a system Hamiltonian at a client according to a relevant physical parameter of a selected target quantum hardware device.

Step b: the user creates a target function based on the VQE algorithm (that is, a second target function) and a corresponding parameterized quantum circuit U(\vec{θ}) on the client side based on a preset template or a self-defined manner.

Step c: the system Hamiltonian and a target quantum control task characterized by the parameterized quantum circuit U(\vec{θ}) are uploaded to a cloud server; on the cloud server side, a mapper is invoked to map logical qubits in the parameterized quantum circuit U(\vec{θ}) onto physical qubits in the target quantum hardware device.

Step d: a quantum logic gate in the parameterized quantum circuit U(\vec{θ}) based on the VQE algorithm is compiled into an initial simulated pulse.

It should be noted that, in actual applications, a parameterized quantum circuit may include a plurality of quantum logic gates, wherein initial simulated pulses corresponding to some of the plurality of quantum logic gates may be preset fixed values, while pulses of other logic gates are non-fixed values, such as randomly generated ones. For example, for a single-qubit-logic-gate, the initial simulated pulse is randomly generated; and for a two-qubit-logic-gate, the initial simulated pulse is a preset fixed value.

Step e: a simulator and an optimizer are invoked to optimize parameters of initial simulated pulses of respective quantum logic gates, to obtain high-fidelity initial control pulses for controlling the quantum logic gates.

Step f: a scheduler is invoked to arrange the initial control pulses output by the optimizer based on the gate sequences of all quantum logic gates included in the parameterized quantum circuit obtained through mapping by the mapper in step c, to obtain an initial pulse sequence.

Step g: a benchmark test module is invoked to obtain a chromatographic pulse sequence for the quantum state chromatography of physical qubits, and the chromatographic pulse sequence is added after the initial pulse sequence.

Step h: a hardware structure is invoked to upload the initial pulse sequence and chromatographic pulse sequence to a quantum processor (i.e., the real target quantum hardware device) through the API of third-party hardware.

Step i: a reader is invoked to process a reading result returned by the quantum processor.

Step j: the reader calculates a density matrix p of the target quantum hardware device (which can characterize the target state information of the target quantum hardware device, which may also be referred to state information characterizing physical qubits in the target quantum hardware device, such as quantum state) and a function value [symbol] H_{vqe} [symbol] for the second target, that is, the expected value mentioned above, based on the reading result.

Step k, the reader determines whether the second target function converges.

Step l: if the second target function does not converge, the parameter \vec{θ} of the parameterized quantum circuit is updated through the optimizer, and returning to step d to optimize pulses. For example, after updating the parameter \vec{θ} of the parameterized quantum circuit, the initial simulated pulse corresponding to a single qubit gate is readjusted, and the initial control pulse and the initial pulse sequence are adjusted.

Step m: if the target function converges, the current initial pulse sequence is taken as the target pulse sequence, and at the same time, the optimized parameterized quantum circuit U(\vec{θ*}), the target pulse sequence and fidelity thereof, the ground state energy, the density matrix, etc. are returned to the client, and visualization processing is performed.

To sum up, the solution of the present disclosure has the following advantages.

Firstly, it has strong universality, the solution of the present disclosure can make the programming adapted to all hardware types possible, and support different quantum hardware to achieve different quantum computing tasks through highly customized bottom-level adaptation compilation flow (i.e., the software process).

Secondly, the adaptive expansibility is strong, that is, users can quickly adapt to the target quantum control task by using abundant internal task templates, and by mean of constructing a workflow, such as pulse optimization, pulse control simulation, interface with third-party hardware to test, compilation of a corresponding pulse sequence of quantum algorithm, etc., without manual calibration and adjustment of pulse parameters, which improves the efficiency of pulse control.

Thirdly, the cloud server cluster can be used to further improve the overall computing efficiency. For example, a cloud service with more powerful computing performance is used to replace traditional local computing. Moreover, the cloud server can use a programming language with higher execution efficiency, to further improve the computing efficiency.

Fourthly, the solution of the present disclosure can establish the communication between modules based on the network communication requirements of the whole process, thus solving the problems of complex communication process and error correction caused by object serialization. At the same time, the optimization control algorithm based on gradient or analytic gradient can be used to solve a time evolution operator of a high-dimensional quantum system numerically, to achieve the optimization and adjustment of parameters in the parameterized quantum circuit.

Part Three: Application Scenarios.

In addition to the VQE algorithm set forth above, the solution of the present disclosure can also solve the following problems, specifically including:
firstly, obtaining high-fidelity pulses for different quantum hardware and different architectures, such as a coupler superconducting circuit, a single-qubit-gate and a two-qubit-gate, which are high-profile recently;
secondly, obtaining a pulse sequence for the parameterized quantum circuit to complete the target quantum control task;
thirdly, achieving the interface with third-party hardware;
fourthly, completing the error analysis in quantum control.

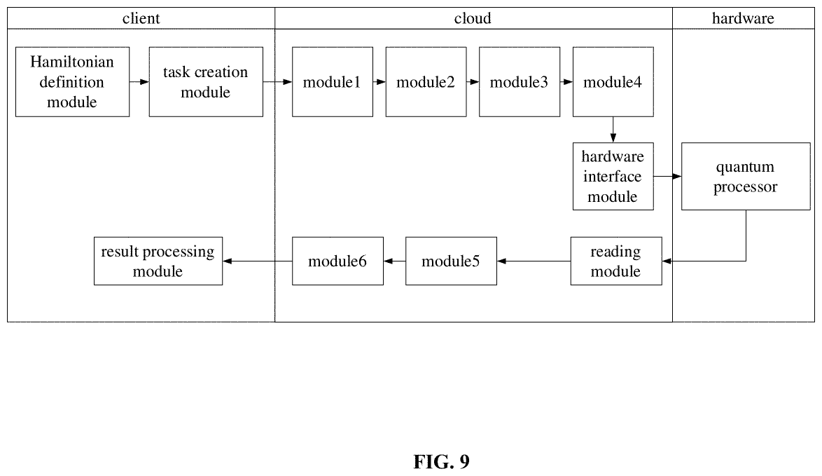

FIG. 9 is a schematic diagram showing the functional modules invoked in the process of achieving different target quantum control tasks according to the solution of the present disclosure, and showing that the target quantum control tasks are achieved based on the invoked functional modules. This schematic diagram is mainly used to illustrate that the cloud server can invoke different modules based on a target quantum control task defined by the client, and the invoked modules can be selected by the user according to the task, and the automatic invoking process is completed, thus achieving the automatic processing of the target quantum control task in terms of pulse, without manual calibration and adjustment of the pulse parameters in this process.

To sum up, the solution of the present disclosure has the following advantages.

First, in terms of functional modules of quantum control: the solution of the present disclosure provides abundant functional modules, such as a simulator, an optimizer, a scheduler, a mapper, a reader, etc., which can be scheduled to perform different quantum control tasks. Moreover, the above modules are connected with and invoked by each other through certain interfaces, and thus the practicability and expansibility is strong.

Second, the flow-based quantum task: the solution of the present disclosure achieves the quantum control task in a flow-based way, that is, different functional modules are invoked and assembled to form an automated workflow. At the same time, the solution of the present disclosure provides abundant quantum task templates, such as the optimal pulse of a logic quantum gate provided by the cloud server, the parameterized quantum circuit charactering the quantum control task provided by the client, etc., so that the whole process is automatically performed according to the quantum control task and the specific quantum hardware information.

Third, the abundant Hamiltonian definition form: on the client side, a user can design a system Hamiltonian based on quantum hardware structures of different physical principles, and assign a value to the designed system Hamiltonian parameter through a self-defined or preset quantum hardware parameter. Then, the cloud server generates a quantum control solution based on the system Hamiltonian and the target quantum control task uploaded by the user, such as, obtaining the target pulse sequence, and achieving the target quantum control task.

To sum up, general quantum control tasks are systematically abstracted, modularized and streamlined by the solution of the present disclosure and a set of powerful interface language is developed to achieve the interface between different modules, thus achieving the target quantum control task specified by the user. In this way, the user can set the target quantum control task according to different requirements, and assemble different control modules to form a complete quantum control workflow. With this modular and streamlined method, it is convenient to interface with different quantum hardware (such as, achieved by using different hardware interfaces), run different quantum algorithms (such as, using a mapper and a scheduler to achieve different quantum algorithms), and invoke different pulse optimization methods (such as, using different optimizers and simulators to achieve different pulse optimization methods), thus greatly improving the expansibility and universality of the quantum control system (that is, the system formed by the client and cloud). Moreover, the cloud server of the solution of the present disclosure can also provide the capability of interfacing with different real quantum computers, thereby achieving the extension of the quantum control system.

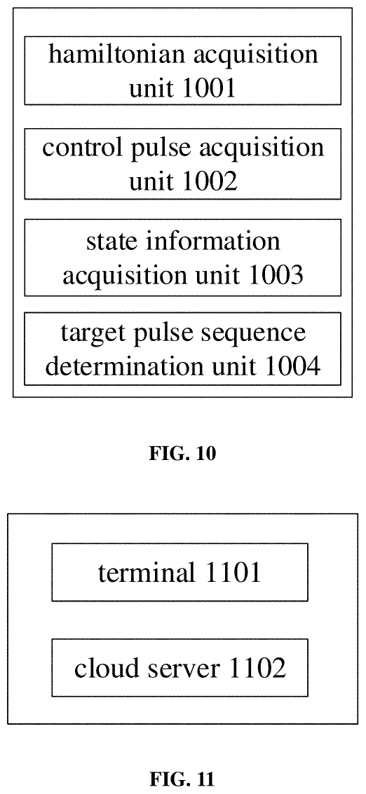

The solution of the present disclosure also provides a control pulse generating apparatus, as shown in FIG. 10, including:
a Hamiltonian acquisition unit 1001 configured to acquire a system Hamiltonian, wherein the system Hamiltonian is constructed based on a relevant physical parameter of a target quantum hardware device and is used for characterizing a Hamiltonian of a quantum system corresponding to the target quantum hardware device; the target quantum hardware device is configured to achieve a target quantum control task, and the target quantum control task is characterized by a parameterized quantum circuit;
a control pulse acquisition unit 1002 configured to acquire an initial control pulse of a quantum logic gate included in the parameterized quantum circuit, to obtain an initial pulse sequence for a gate sequence formed for all the quantum logic gates in the parameterized quantum circuit, wherein the initial control pulse is obtained through simulation based on the system Hamiltonian;
a state information acquisition unit 1003 configured to acquire system state information of the quantum system obtained after applying the initial pulse sequence to the target quantum hardware device;
a target pulse sequence determination unit 1004 configured to adjust a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

In a specific example of the solution of the present disclosure, further includes:
a simulated pulse acquisition unit configured to acquire an initial simulated pulse of the quantum logic gate included in the parameterize quantum circuit;
a dynamic evolution unit configured to perform dynamical evolution processing on the system Hamiltonian based on the initial simulated pulse of the quantum logic gate included in the parameterized quantum circuit, to simulate the application of the initial simulated pulse to physical qubits in the target quantum hardware device, and simulate to obtain a simulated quantum gate achieved by the initial simulated pulse;
an optimization unit configured to optimize a pulse parameter of the initial simulated pulse based on a relationship between the simulated quantum gate obtained through simulation and the quantum logic gate, to obtain the initial control pulse of the quantum logic gate included in the parameterized quantum circuit, wherein an approximate quantum logic gate can be obtained based on the initial control pulse, and a fidelity of the approximate quantum logic gate from the quantum logic gate meets a preset fidelity rule.

In a specific example of the solution of the present disclosure, further includes a first target function determination unit; wherein
the first target function determination unit is configured to evolve to obtain a first target function at least based on the system Hamiltonian and the logical quantum gate included in the parameterized quantum circuit, wherein the first target function can characterize the relationship between the simulated quantum gate obtained by simulating the application of the initial pulse sequence to the target quantum hardware device and the logical quantum gate included in the parameterized quantum circuit;
the optimization unit is further configured to: optimize the pulse parameter of the initial simulated pulse to minimize the first target function to obtain a minimum function value, wherein a simulated quantum gate corresponding to the minimum function value is the approximate quantum logic gate; take a simulated pulse corresponding to the minimum function value as the initial control pulse of the quantum logic gate included in the parameterized quantum circuit.

In a specific example of the solution of the present disclosure, further includes a mapping unit, wherein
the mapping unit is configured to map logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
the control pulse acquisition unit is configured to perform, in a case that there are two or more quantum logic gates included in the parameterized quantum circuit, timing and/or order based optimization processing on the initial control pulses of the respective quantum logic gates included in the parameterized quantum circuit based on the mapping relationship characterized by the target parameterized quantum circuit, and simulate to obtain the initial pulse sequence;
wherein the approximate quantum logic gate can be obtained based on the control pulse included in the initial pulse sequence, and a fidelity of the approximate quantum logic gate from the quantum logic gate meets a preset fidelity rule.

In a specific example of the solution of the present disclosure, further includes a chromatographic pulse sequence acquisition unit and a measurement result acquisition unit, wherein
the chromatographic pulse sequence acquisition unit is configured to acquire a chromatographic pulse sequence;
the measurement result acquisition unit is configured to acquire a measurement result returned after applying the chromatographic pulse sequence, after the target pulse sequence is applied to the target quantum hardware device;
the state information acquisition unit is further configured to obtain state information of each physical qubit in the target quantum hardware device based on the measurement result, to obtain the system state information of the quantum system.

In a specific example of the solution of the present disclosure, further includes a second target function determination unit; wherein
the second target function determination unit is configured to: acquire a second target function for the parameterized quantum circuit; calculate a function value corresponding to the system state information based on the second target function;
the target pulse sequence determination unit is further configured to: adjust, in a case that it is determined that the second target function does not meet a function rule based on the function value corresponding to the system state information, the parameter of the parameterized quantum circuit to adjust the pulse parameter of the initial pulse sequence, and newly obtain system station information corresponding to an adjusted initial pulse sequence and newly obtain a function value, until the second target function meets the function rule; and take an initial pulse sequence from which the function rule is met as the target pulse sequence.

In a specific example of the solution of the present disclosure, further includes:
a visualization unit configured to take at least the system state information of the quantum system as an output result, and display the output result in a visual interactive interface.

The functions of each unit in the control pulse generation apparatus according to the embodiment of the present invention can be referred to the corresponding description in the above method, which will not be repeated herein.

The solution of the present disclosure also provides a control pulse generation system, as shown in FIG. 11, at least including: a terminal and a cloud server; wherein
the terminal 1101 is configured to receive a relevant physical parameter of a target quantum hardware device input by a user and construct a system Hamiltonian characterizing the target quantum hardware device; the target quantum hardware device is configured to achieve a target quantum control task, and the target quantum control task is characterized by a parameterized quantum circuit;
the cloud server 1102 is configured to: acquire the system Hamiltonian; acquire an initial control pulse of a quantum logic gate included in the parameterized quantum circuit, to obtain an initial pulse sequence for a gate sequence formed for all the quantum logic gates in the parameterized quantum circuit, wherein the initial control pulse is obtained through simulation based on the system Hamiltonian; acquire system state information of the quantum system obtained after applying the initial pulse sequence to the target quantum hardware device; and adjust a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

Here, the functions of the cloud server and the client in the system can refer to the corresponding description in the above method, which will not be repeated herein.

According to an embodiment of the present disclosure, the present disclosure also provides an electronic device, a readable storage medium and a computer program product.

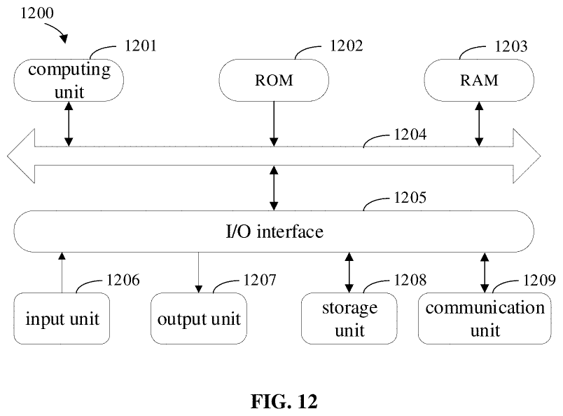

FIG. 12 shows a schematic block diagram of an exemplary electronic device 1200 that can be used to implement embodiments of the present disclosure. The electronic devices is intended to represent various forms of digital computers, such as laptop computers, desktop computers, workbenches, personal digital assistants, servers, blade servers, mainframe computers, and other suitable computers. The electronic device can also represent various forms of mobile apparatus, such as personal digital processors, cellular phones, smart phones, wearable devices and other similar computing devices. The components, their connections and relationships, and their functions shown herein are merely examples, and are not intended to limit the implementation of the disclosure described and/or claimed herein.

As shown in FIG. 12, the electronic device 1200 includes a computing unit 1201, which can perform various appropriate actions and processes according to a computer program stored in a read only memory (ROM) 1202 or a computer program loaded from a storage unit 1208 into a random access memory (RAM) 1203. In the RAM 1203, various programs and data required for the operation of the electronic device 1200 can also be stored. A computing unit 1201, a ROM 1202, and a RAM 1203 are connected to each other through a bus 1204. Input/output (I/O) interface 1205 is also connected to the bus 1204.

A plurality of components in the electronic device 1200 are connected to the I/O interface 1205, including an input unit 1206, such as a keyboard, a mouse, and the like; an output unit 1207, such as various types of displays and speakers; a storage unit 1208, such as a magnetic disk, an optical disk, etc.; and a communication unit 1209, such as a network card, a modem, a wireless communication transceiver, etc. The communication unit 1209 allows the electronic device 1200 to exchange information/data with other devices through a computer network such as the Internet and/or various telecommunication networks.

The computing unit 1201 may be various general-purpose and/or special-purpose processing components with processing and computing capabilities. Some examples of the computing unit 1201 include, but not limited to, a central processing unit (CPU), a graphics processing unit (GPU), various dedicated artificial intelligence (AI) computing chips, various computing units running machine learning model algorithms, a digital signal processor (DSP), and any appropriate processors, controllers, microcontrollers, etc. The computing unit 1201 performs various methods and processes described above, for example a control pulse generation method. For example, in some embodiments, the control pulse generation method may be implemented as a computer software program, which is tangibly included in a machine-readable medium, for example a storage unit 1208. In some embodiments, part or all of the computer program may be loaded and/or installed on the electronic device 1200 via the ROM 1202 and/or the communication unit 1209. If the computer program is loaded into the RAM 1203 and executed by the computing unit 1201, one or more steps of the control pulse generation method described above may be performed. Alternatively, in other embodiments, the computing unit 1201 may be configured to perform the control pulse generation method by any other appropriate means (for example, by means of firmware).

The various implementations of the systems and techniques described above herein may be implemented in digital electronic circuit systems, integrated circuit systems, field programmable gate arrays (FPGA), application specific integrated circuits (ASIC), application specific standard products (ASSP), systems on a chip (SOC), load programmable logic devices (CPLD), computer hardware, firmware, software, and/or combinations thereof. These various implementations may include being implemented in one or more computer programs that can be executed and/or interpreted on a programmable system including at least one programmable processor, which can be a special purpose or general purpose programmable processor and can receive data and instructions from and transmit the data and instructions to a storage system, at least one input apparatus, and at least one output apparatus.

Program code for implementing the method of the present disclosure may be written in any combination of one or more programming languages. The program code may be provided to a processor or controller of a general purpose computer, a special purpose computer, or other programmable data processing apparatus, such that the program code, when executed by the processor or controller, cause the functions/operations specified in the flowcharts and/or block diagrams to be implemented. The program code may be executed entirely or partially on a machine, partly executed on a machine and a remote machine, or entirely executed on a remote machine or a server as an independent software package.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but not limited to, electronic, magnetic, optical, electromagnetic, infrared, or semiconductor systems, apparatuses, or devices, or any suitable combination of the above. More specific examples of the machine-readable storage medium may include one or more a wire-based electrical connection, a portable computer disk, a hard disk, a random access memory (RAM), a read-only memory (ROM), a erasable programmable read-only memory (EPROM or flash memory), an optical fiber, a portable compact disc read-only memory (CD-ROM), an optical storage device, a magnetic storage device, or any suitable combination of the above.

To provide interaction with a user, the systems and techniques described herein can be implemented on a computer having a display apparatus (e.g., a CRT (cathode ray tube) or LCD (liquid crystal display) monitor) for displaying information to the user; as well as a keyboard and a pointing apparatus (e.g., a mouse or a trackball) through which the user can provide input to the computer. Other kinds of apparatuses can also be used to provide interaction with users; for example, the feedback provided to the user can be any form of sensory feedback (for example, visual feedback, auditory feedback, or tactile feedback); and input from the user may be received in any form, including acoustic input, voice input, or tactile input.

The systems and technologies described herein can be implemented in a computing system including background components (e.g., a data server), a computing system including middleware components (e.g., an application server), or a computing system including front-end components (e.g., a user computer with a graphical user interface or a web browser through which the user can interact with implementations of the systems and technologies described herein), or a computing system including any combination of such back-end components, middleware components, or front-end components. Components of the system can be connected to each other through digital data communication in any form or medium (e.g., communication network). Examples of communication networks include local area networks (LANs), wide area networks (WANs), and the Internet.

A computer system may include a client and a server. The client and server are generally remote from each other and usually interact through communication networks. The relationship between the client and server is created by running a computer program that has a client-server relationship on a corresponding computer.

It should be understood that the steps in the various processes described above may be reordered or omitted, or other steps may be added therein. For example, the steps described in the present disclosure may be performed in parallel or sequentially or may be performed in a different order, so long as the desired result of the technical solutions disclosed in the present disclosure can be achieved, and no limitation is made herein.

Above specific embodiments do not constitute a limitation on the protection scope of the present disclosure. It should be understood by those skilled in the art that various modifications, combinations, sub-combinations, and substitutions may be available according to design requirements and other factors. Any modifications, equivalent replacements and improvements made within the spirit and principle of the present disclosure shall be covered within the protection scope of the present disclosure.

1. A control pulse generation method, comprising:
acquiring a system Hamiltonian, wherein the system Hamiltonian is constructed based on a relevant physical parameter of a target quantum hardware device and is used for characterizing a Hamiltonian of a quantum system corresponding to the target quantum hardware device; the target quantum hardware device is configured to achieve a target quantum control task, and the target quantum control task is characterized by a parameterized quantum circuit;
acquiring an initial control pulse of a quantum logic gate comprised in the parameterized quantum circuit, to obtain an initial pulse sequence for a gate sequence formed for all the quantum logic gates in the parameterized quantum circuit, wherein the initial control pulse is obtained through simulation based on the system Hamiltonian;
acquiring system state information of the quantum system obtained after applying the initial pulse sequence to the target quantum hardware device;
adjusting a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

2. The method according to claim 1, further comprising:
acquiring an initial simulated pulse of the quantum logic gate comprised in the parameterize quantum circuit;
performing dynamical evolution processing on the system Hamiltonian based on the initial simulated pulse of the quantum logic gate comprised in the parameterized quantum circuit, to simulate the application of the initial simulated pulse to physical qubits in the target quantum hardware device, and simulating to obtain a simulated quantum gate achieved by the initial simulated pulse;
optimizing a pulse parameter of the initial simulated pulse based on a relationship between the simulated quantum gate obtained through simulation and the quantum logic gate, to obtain the initial control pulse of the quantum logic gate comprised in the parameterized quantum circuit, wherein an approximate quantum logic gate can be obtained based on the initial control pulse, and a fidelity of the approximate quantum logic gate from the quantum logic gate meets a preset fidelity rule.

3. The method according to claim 2, further comprising:
evolving to obtain a first target function at least based on the system Hamiltonian and the logical quantum gate comprised in the parameterized quantum circuit, wherein the first target function can characterize the relationship between the simulated quantum gate obtained by simulating the application of the initial pulse sequence to the target quantum hardware device and the logical quantum gate comprised in the parameterized quantum circuit;
wherein optimizing the pulse parameter of the initial simulated pulse based on the relationship between the simulated quantum gate obtained by simulation and the quantum logic gate to obtain the initial control pulse of the quantum logic gate comprised in the parameterized quantum circuit comprises:
optimizing the pulse parameter of the initial simulated pulse to minimize the first target function to obtain a minimum function value, wherein a simulated quantum gate corresponding to the minimum function value is the approximate quantum logic gate;
taking a simulated pulse corresponding to the minimum function value as the initial control pulse of the quantum logic gate comprised in the parameterized quantum circuit.

4. The method according to claim 1, further comprising:
mapping logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
wherein obtaining the initial pulse sequence for the gate sequence formed for all the quantum logic gates in the parameterized quantum circuit comprises:
performing, in a case that there are two or more quantum logic gates comprised in the parameterized quantum circuit, timing and/or order based optimization processing on the initial control pulses of the respective quantum logic gates comprised in the parameterized quantum circuit based on the mapping relationship characterized by the target parameterized quantum circuit, and simulating to obtain the initial pulse sequence;
wherein the approximate quantum logic gate can be obtained based on the control pulse comprised in the initial pulse sequence, and a fidelity of the approximate quantum logic gate from the quantum logic gate meets a preset fidelity rule.

5. The method according to claim 2, further comprising:
mapping logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
wherein obtaining the initial pulse sequence for the gate sequence formed for all the quantum logic gates in the parameterized quantum circuit comprises:
performing, in a case that there are two or more quantum logic gates comprised in the parameterized quantum circuit, timing and/or order based optimization processing on the initial control pulses of the respective quantum logic gates comprised in the parameterized quantum circuit based on the mapping relationship characterized by the target parameterized quantum circuit, and simulating to obtain the initial pulse sequence;
wherein the approximate quantum logic gate can be obtained based on the control pulse comprised in the initial pulse sequence, and a fidelity of the approximate quantum logic gate from the quantum logic gate meets a preset fidelity rule.

6. The method according to claim 3, further comprising:
mapping logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
wherein obtaining the initial pulse sequence for the gate sequence formed for all the quantum logic gates in the parameterized quantum circuit comprises:
performing, in a case that there are two or more quantum logic gates comprised in the parameterized quantum circuit, timing and/or order based optimization processing on the initial control pulses of the respective quantum logic gates comprised in the parameterized quantum circuit based on the mapping relationship characterized by the target parameterized quantum circuit, and simulating to obtain the initial pulse sequence;
wherein the approximate quantum logic gate can be obtained based on the control pulse comprised in the initial pulse sequence, and a fidelity of the approximate quantum logic gate from the quantum logic gate meets a preset fidelity rule.

7. The method according to claim 1, further comprising:
acquiring a chromatographic pulse sequence;
acquiring a measurement result returned after applying the chromatographic pulse sequence, after the target pulse sequence is applied to the target quantum hardware device;
wherein acquiring the system state information of the quantum system obtained after applying the initial pulse sequence to the target quantum hardware device comprises:
obtaining state information of each physical qubit in the target quantum hardware device based on the measurement result, to obtain the system state information of the quantum system.

8. The method according to claim 1, further comprising:
acquiring a second target function for the parameterized quantum circuit;
calculating a function value corresponding to the system state information based on the second target function;
wherein adjusting the parameter of the parameterized quantum circuit based on the relationship between the system state information and the target state information needed to be achieved by the target quantum control task, to adjust the pulse parameter of the initial pulse sequence to obtain the target pulse sequence comprises:
adjusting, in a case that it is determined that the second target function does not meet a function rule based on the function value corresponding to the system state information, the parameter of the parameterized quantum circuit to adjust the pulse parameter of the initial pulse sequence; and newly obtaining system station information corresponding to an adjusted initial pulse sequence and newly obtaining a function value, until the second target function meets the function rule; and
taking an initial pulse sequence from which the function rule is met as the target pulse sequence.

9. The method according to claim 1, further comprising:
taking at least the system state information of the quantum system as an output result; and
displaying the output result in a visual interactive interface.

10. A control pulse generation system, at least comprising a terminal and a cloud server; wherein
the terminal is configured to receive a relevant physical parameter of a target quantum hardware device input by a user, and construct a system Hamiltonian characterizing the target quantum hardware device; the target quantum hardware device is configured to achieve a target quantum control task, and the target quantum control task is characterized by a parameterized quantum circuit;
the cloud server is configured to: acquire the system Hamiltonian; acquire an initial control pulse of a quantum logic gate comprised in the parameterized quantum circuit, to obtain an initial pulse sequence for a gate sequence formed for all the quantum logic gates in the parameterized quantum circuit, wherein the initial control pulse is obtained through simulation based on the system Hamiltonian; acquire system state information of the quantum system obtained after applying the initial pulse sequence to the target quantum hardware device; and adjust a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

11. An electronic device, comprising:
at least one processor; and
a memory communicatively connected to the at least one processor, wherein
the memory stores instructions executable by the at least one processor, and the instructions are executed by the at least one processor to cause the at least one processor to:
acquire a system Hamiltonian, wherein the system Hamiltonian is constructed based on a relevant physical parameter of a target quantum hardware device and is used for characterizing a Hamiltonian of a quantum system corresponding to the target quantum hardware device; the target quantum hardware device is configured to achieve a target quantum control task, and the target quantum control task is characterized by a parameterized quantum circuit;
acquire an initial control pulse of a quantum logic gate comprised in the parameterized quantum circuit, to obtain an initial pulse sequence for a gate sequence formed for all the quantum logic gates in the parameterized quantum circuit, wherein the initial control pulse is obtained through simulation based on the system Hamiltonian;
acquire system state information of the quantum system obtained after applying the initial pulse sequence to the target quantum hardware device;
adjust a parameter of the parameterized quantum circuit based on a relationship between the system state information and target state information needed to be achieved by the target quantum control task, to adjust a pulse parameter of the initial pulse sequence to obtain a target pulse sequence, wherein the target quantum control task can be achieved after the target pulse sequence is applied to the target quantum hardware device.

12. The electronic device according to claim 11, wherein the instructions are executed by the at least one processor to cause the at least one processor to:
acquire an initial simulated pulse of the quantum logic gate comprised in the parameterize quantum circuit;
perform dynamical evolution processing on the system Hamiltonian based on the initial simulated pulse of the quantum logic gate comprised in the parameterized quantum circuit, to simulate the application of the initial simulated pulse to physical qubits in the target quantum hardware device, and simulate to obtain a simulated quantum gate achieved by the initial simulated pulse;
optimize a pulse parameter of the initial simulated pulse based on a relationship between the simulated quantum gate obtained through simulation and the quantum logic gate, to obtain the initial control pulse of the quantum logic gate comprised in the parameterized quantum circuit, wherein an approximate quantum logic gate can be obtained based on the initial control pulse, and a fidelity of the approximate quantum logic gate from the quantum logic gate meets a preset fidelity rule.

13. The electronic device according to claim 12, wherein the instructions are executed by the at least one processor to cause the at least one processor to:
evolve to obtain a first target function at least based on the system Hamiltonian and the logical quantum gate comprised in the parameterized quantum circuit, wherein the first target function can characterize the relationship between the simulated quantum gate obtained by simulating the application of the initial pulse sequence to the target quantum hardware device and the logical quantum gate comprised in the parameterized quantum circuit;
optimize the pulse parameter of the initial simulated pulse to minimize the first target function to obtain a minimum function value, wherein a simulated quantum gate corresponding to the minimum function value is the approximate quantum logic gate; take a simulated pulse corresponding to the minimum function value as the initial control pulse of the quantum logic gate comprised in the parameterized quantum circuit.

14. The electronic device according to claim 11, wherein the instructions are executed by the at least one processor to cause the at least one processor to:
map logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
perform, in a case that there are two or more quantum logic gates comprised in the parameterized quantum circuit, timing and/or order based optimization processing on the initial control pulses of the respective quantum logic gates comprised in the parameterized quantum circuit based on the mapping relationship characterized by the target parameterized quantum circuit, and simulate to obtain the initial pulse sequence;
wherein the approximate quantum logic gate can be obtained based on the control pulse comprised in the initial pulse sequence, and a fidelity of the approximate quantum logic gate from the quantum logic gate meets a preset fidelity rule.

15. The electronic device according to claim 12, wherein the instructions are executed by the at least one processor to cause the at least one processor to:
map logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
perform, in a case that there are two or more quantum logic gates comprised in the parameterized quantum circuit, timing and/or order based optimization processing on the initial control pulses of the respective quantum logic gates comprised in the parameterized quantum circuit based on the mapping relationship characterized by the target parameterized quantum circuit, and simulate to obtain the initial pulse sequence;
wherein the approximate quantum logic gate can be obtained based on the control pulse comprised in the initial pulse sequence, and a fidelity of the approximate quantum logic gate from the quantum logic gate meets a preset fidelity rule.

16. The electronic device according to claim 13, wherein the instructions are executed by the at least one processor to cause the at least one processor to:
map logical qubits in the parameterized quantum circuit onto the physical qubits in the target quantum hardware device based on a physical connectivity among the physical qubits in the target quantum hardware device, to obtain a target parameterized quantum circuit characterizing a mapping relationship between the logical qubits and the physical qubits;
perform, in a case that there are two or more quantum logic gates comprised in the parameterized quantum circuit, timing and/or order based optimization processing on the initial control pulses of the respective quantum logic gates comprised in the parameterized quantum circuit based on the mapping relationship characterized by the target parameterized quantum circuit, and simulate to obtain the initial pulse sequence;
wherein the approximate quantum logic gate can be obtained based on the control pulse comprised in the initial pulse sequence, and a fidelity of the approximate quantum logic gate from the quantum logic gate meets a preset fidelity rule.

17. The electronic device according to claim 11, wherein the instructions are executed by the at least one processor to cause the at least one processor to:
acquire a chromatographic pulse sequence;
acquire a measurement result returned after applying the chromatographic pulse sequence, after the target pulse sequence is applied to the target quantum hardware device;
obtain state information of each physical qubit in the target quantum hardware device based on the measurement result, to obtain the system state information of the quantum system.

18. The electronic device according to claim 11, wherein the instructions are executed by the at least one processor to cause the at least one processor to:
acquire a second target function for the parameterized quantum circuit; calculate a function value corresponding to the system state information based on the second target function;
adjust, in a case that it is determined that the second target function does not meet a function rule based on the function value corresponding to the system state information, the parameter of the parameterized quantum circuit to adjust the pulse parameter of the initial pulse sequence; newly obtain system station information corresponding to an adjusted initial pulse sequence and newly obtain a function value, until the second target function meets the function rule; and
take an initial pulse sequence from which the function rule is met as the target pulse sequence.

19. The electronic device according to claim 11, wherein the instructions are executed by the at least one processor to cause the at least one processor to:
take at least the system state information of the quantum system as an output result, and
display the output result in a visual interactive interface.
